(19) United States
(12) Patent Application Publication
(10) Pub. No.: US 2011/0035367 A1
(43) Pub. Date: Feb. 10, 2011

(54) Methods And System For Efficient Crawling Of Advertiser Landing Page URLs

(76) Inventors: Ankur K. Gupta, Sunnyvale, CA (US); Veaceslav D. Filimonov, Santa Clara, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/538,070

(22) Filed: Aug. 7, 2009

(51) Int. Cl. G06F 17/30

(52) U.S. Cl. 707/709; 707/E17.108

(57) ABSTRACT

A method and apparatus for the efficient storage, retrieval, and processing of landing pages and related metadata for use in a paid search advertising business model is provided. These techniques promote efficient crawling in situations including one landing page associated with multiple sponsored listings belonging to the same or different accounts. One or more landing pages may be crawled, based at least in part on one or more of the landing page URLs represented in a table. In an embodiment, each URL identifier is placed in an active or inactive queue, with only entries in the active queue crawled.

### FIELD OF THE INVENTION

The present invention relates to crawling of advertising landing pages.

### BACKGROUND

The phenomenal growth and importance of search engines has helped propel the Internet into a vast repository of accessible knowledge. Search engines have also become engines of commerce through the addition of paid search advertising to search results. Paid search advertising, also known as ‘sponsored listings’, brings useful products and services to the attention of search users. A search engine can match sellers to potential customers through techniques such as keyword mapping, in which advertisers actively bid on keywords. These keywords are matched against a user query to select the sponsored listings displayed to the user. As used herein, a “sponsored listing” comprises (1) a set of keywords used to trigger display of the sponsored listing ad copy, (2) the ad copy, along with (3) a title, (4) a description, and (5) a web address known as a “click URL.”

Typically, after a user issues a search query, the user is provided search results based on the search query. The user is also provided with a separate sponsored listing ad copy from each of one or more advertisers. Each sponsored listing ad copy contains an accompanying click URL. Should the user select the click URL, also known as a “landing page URL,” the user is sent to a landing page containing the complete advertisement.

Landing page content plays an important role in selection and ranking of a sponsored listing among all selected sponsored listings for a given user query. However, the utility of paid search advertising can be hijacked by nefarious advertisers. Such an advertiser might attempt to draw high traffic to particular websites by bidding on irrelevant keywords or creating misleading sponsored listing titles and descriptions. For example, an off-brand shoe seller could bid on premium shoe brand keywords such as “Nike” or “Reebok,” or create sponsored listings containing name-brand shoe manufactures as keywords.

Other problematic scenarios are possible. For example, an advertiser could alter a landing page so that a search on the phrase “stuffed animal” could present the user with a click URL leading to an advertisement for a male enhancement product or other product of a sensitive nature or dubious value. At a minimum, such undesirable outcomes create a negative user experience and are ultimately detrimental to the search engine provider.

These considerations lead to use of a crawling system that determines landing page content and content quality, and ensures semantic meanings among landing page content, paid listing title, description, and keywords are properly aligned. However, the sponsored listing marketplace is both vast and fluid. An advertising campaign may only last a few hours, may be arbitrarily halted and restarted, and may coincide with intermittent or recurring events, such as a campaign related to sales of flowers near Mother's Day. An advertising campaign may direct several sets of keywords to identical landing pages. Unless handled, a huge number of unused or duplicated landing pages could clog a crawler and waste disk space, computing time, and energy.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a landing page crawler system;

FIG. 2 depicts a data structure mapping between URL identifier, landing page URL, and meta information;

FIG. 3 depicts a method of performing efficient crawling of an advertiser landing page database;

FIG. 4 depicts a method of transitioning landing page URLs from an Active Queue to a Sleeping Queue, and vice versa; and

FIG. 5 depicts a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for the efficient storage, retrieval, and processing of landing pages and related metadata for use in a paid search advertising business model. These techniques promote efficient crawling in situations including one landing page associated with multiple sponsored listings belonging to the same or different accounts.

In an embodiment, in response to acceptance of a landing page URL submitted by an entity, a process determines whether the landing page URL is already represented in a table. In response to determining that the landing page URL is already represented in the table, the process adds entity information about the entity to a table entry corresponding to the landing page URL. Then one or more landing pages may be crawled, based at least in part on one or more of the landing page URLs represented in the table.

In an embodiment, a URL identifier associated with a landing page URL and the corresponding landing page is placed in an active queue. One or more landing pages on the active queue are crawled. A time interval since a last active sponsored listing associated with the URL identifier has become inactive is determined. If the time interval is greater than a pre-selected duration, then the URL identifier is placed on an inactive queue and any stored copies of the corresponding landing page are discarded. If a sponsored listing associated with a URL identifier in the inactive queue is activated, then the URL identifier in the inactive queue is moved to the active queue and the corresponding landing page is placed in the active queue.

### Example Crawler System

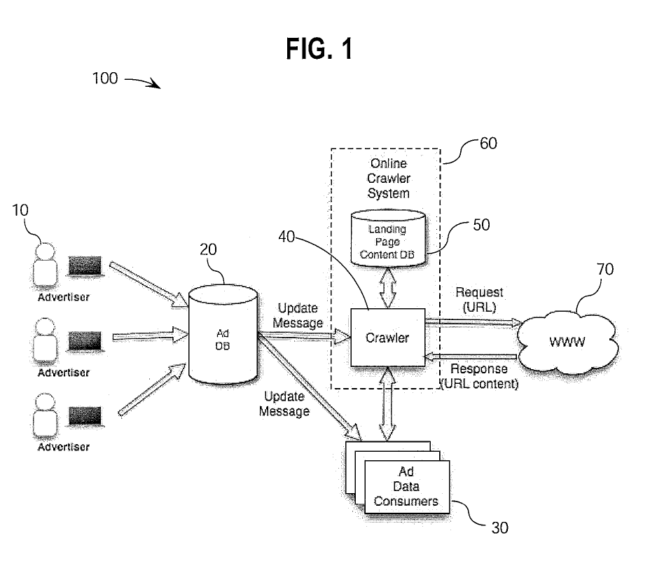

FIG. 1 depicts a landing page crawler system 100. Landing page crawler system 100 includes ad database 20, (optional) ad data consumers 30, and online crawler system 60. Online crawler system 60 comprises crawler 40 and landing page content database 50. Landing page crawler system 100 may reside on one computing system. Alternatively, landing page crawler system 100 may comprise multiple computing systems. For example, separate computing systems may be used for ad database 20, (optional) ad data consumers 30, crawler 40 and landing page content database 50.

Advertisers 10 maintain accounts on ad database 20 and create, modify, and delete sponsored listings residing on ad database 20. Ad database 20 may be a conventional relational database residing on a computer accessible to each advertiser 10. In an embodiment, ad database 10 operates on one or more servers operated by the search engine provider. As advertisers 10 manipulate sponsored listings residing on ad database 20, update messages are sent to crawler 40 and (optional) ad data consumers 30. Update messages may be delivered using conventional techniques such as electronic mail, instant messaging, or RSS feeds, or using other methods.

In an embodiment, an update message for a sponsored listing includes a landing page URL. In an embodiment, an update message for a sponsored listing includes meta information such as an account identifier identifying advertiser 10 and a sponsored listing identifier identifying a particular sponsored listing.

Part or all of the update message information received by crawler 40 is communicated to landing page content database 50. Using the techniques described herein, crawler 40 performs crawling operations upon landing pages requested from Internet 70 using each landing page's landing page URL supplied by an advertiser. Part or all of the landing page information collected by crawler 40 is stored in landing page content database 50. In an embodiment, landing page information stored in landing page content database 50 is transmitted to one or more search engines (not shown in FIG. 1) responding to a user's search query. The landing page information is used to construct part or all of the “sponsored listings” information transmitted to the user in response to the user's search query.

In an embodiment, landing page information stored in landing page content database 50 is transmitted to one or more or computers (not shown in FIG. 1) in response to a user interaction with a mobile device such as a cellular telephone. This landing page information is used to construct part or all of a set of advertising information transmitted to the mobile device. For example, a user interacting with the “oneSearch” mobile platform may receive sponsored listings based upon user metadata such as the user's current location.

In an embodiment, landing page information stored in landing page content database 50 is transmitted to (optional) ad data consumers 30. Ad data consumers 30 represents additional systems connected to both ad database 20 and online crawler system 60. Ad data consumers 30 comprises systems used to monitor online crawler system 60; for example, ad data consumers 30 may analyze landing page content from landing page content database 50 for data quality and relevance of the information from landing page content database 50 that is passed along to the user.

### Example Data Structure

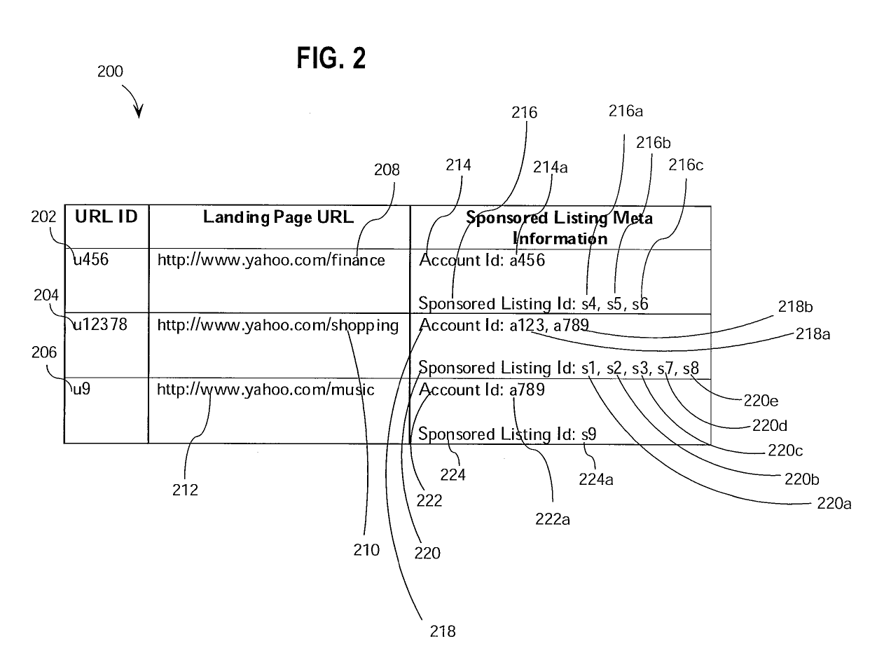

Large disk space savings and other benefits may be achieved by landing page crawler system 100 through use of data structures capable of handling the fluid nature of the sponsored listing business model. FIG. 2 depicts example data structure 200 providing a mapping between URL identifier, landing page URL, and meta information. Data structure 200 contains the landing page URLs to be crawled by crawler 40. Of course, data structure 200 is illustrative and presented to facilitate understanding by the reader. An actual implementation may deviate from the appearance of FIG. 2 yet still adhere to the principles disclosed herein.

Example data structure 200 has three separate URL identifiers 202, 204, and 206, with each URL identifier corresponding to landing page URLs 208, 210, and 212. Each URL identifier/landing page URL/sponsored listing meta information combination corresponds to a record in example data structure 200. By virtue of the construction of the database as described below, each landing page URL is unique, unlike conventional approaches in which the same landing page URL may occupy thousands of records of a database. Thus, crawler 40 needs only crawl each landing page once per update, thereby eliminating enormous overhead and duplication.

While URL identifiers 202, 204, and 206 are not needed to practice the invention, in this example, short URL identifiers such as “u456” are generally more human-readable than a landing page URL which may be hundreds or thousands of characters long. Short URL identifiers also may be processed more efficiently than landing page URLs. In an embodiment, URL identifiers 202, 204, and 206 are determined by a hashing function applied to corresponding landing page URLs 208, 210, and 212.

In an embodiment, accompanying each landing page URL 202, 204, and 206 is one or more items of meta information connecting the landing page URL to one or more accounts and one or more sponsored listing identifiers. Embodiments could include different types of meta information depending upon the needs of the system.

In FIG. 2, URL identifier 202 has the value “u456” and identifies landing page URL 208 having value “http://www.yahoo.com/finance.” This landing page belongs to account identifier entry 214 having value 214a of “a456” and referred to by sponsored listing identifier entry 216 having value 216a of “s4,” value 216b of “s5,” and value 216c of “s6.” In this example, three separate sponsored listing identifiers may lead to the same landing page for Yahoo! Finance.

The second row of example data structure 200 illustrates a landing page URL having value 218a of “a123” and value 218b of “a789” for account identifier entry 218, and having value 220a of “s1” through value 220e of “s8” for sponsored listings identifier entry 220. Such a set of multiple account identifier values may occur when a particular entity, such as an advertiser, associates multiple sponsored listings among multiple accounts.

Finally, the third row of example data structure 200 illustrates a landing page URL associated with an account identifier already in data structure 200—here account identifier entry 222 having value 222a of “a789” is also found in the values of account identifier entry 218 at value 218b. Thus, in this example, nine separate sponsored listings are represented by three unique landing page URLs, a significant savings. Significantly, in one embodiment, the table contains no more than one row for any given landing page URL.

### Example Method of Operation

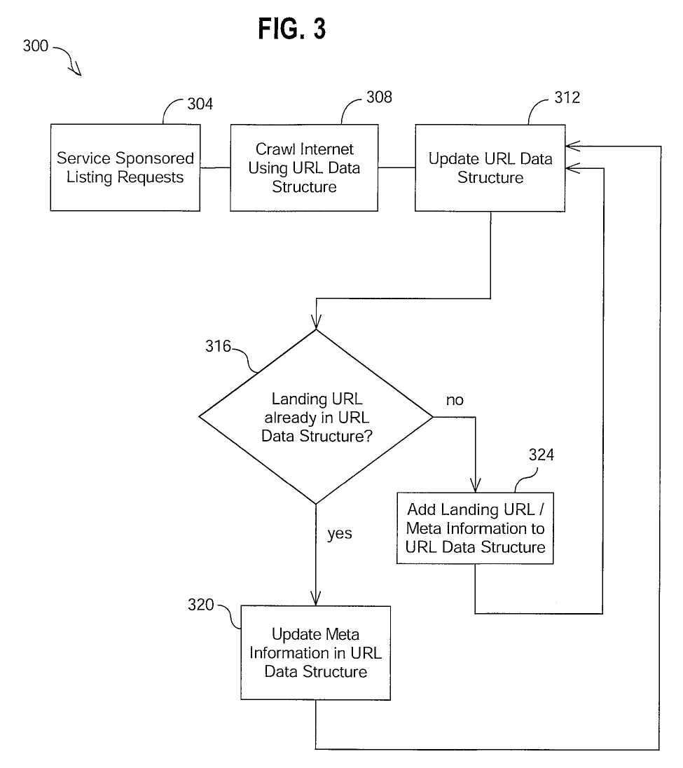

FIG. 3 depicts an example method of performing efficient crawling of an advertiser landing page database in conjunction with the example crawler system of FIG. 1 and the example data structure of FIG. 2.

Typical operation of landing page crawler system 100 is represented as three concurrent processes. In process 304, landing page content database 50 is accessed by one or more systems in order to generate sponsored listings in response to a request such as a search query.

Concurrently in process 304, landing page crawler system 100 performs crawl operations upon Internet 70 using online crawler system 60 and data structure 200.

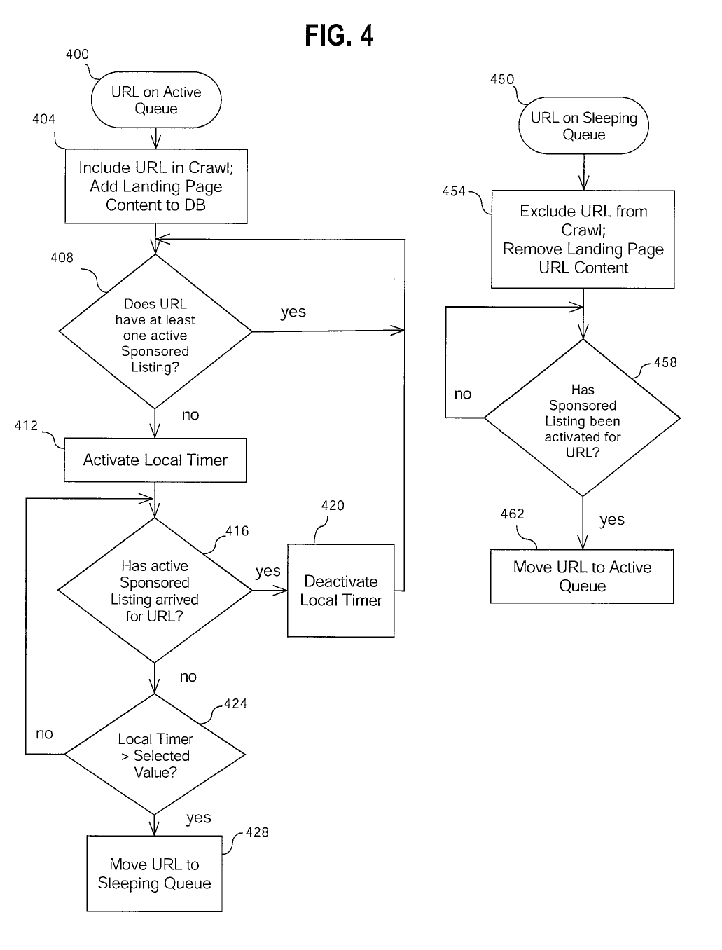

Concurrently in process 312, data structure 200 is updated. Updating of data structure 200 may occur in response to receipt of update messages indicating that advertisers have altered ad database 20. Updating of data structure 200 may occur in response to changes in the queues described further below and with reference to FIG. 4. Updating of data structure 200 may occur in response to other administrative changes.

Once process 312 is activated with respect to a particular landing page URL, at process 316 a determination is made as to whether the landing page URL is already located in data structure 200.

Should the landing page URL be found in data structure 200, then at step 320 only meta information (such as a new sponsored listing identifier or a new account identifier) is inserted into the record containing the landing page URL. A new record is not created in this case. Resumption of process 312 follows.

Should the landing page URL not be found in data structure 200, then at step 324 a new record containing the new landing page URL and accompanying meta information is added to data structure 200. Resumption of operation follows at process 312.

In this example, both process 304 and process 308 operate continuously; however, many variations are possible. For example, process 304 may be dormant until a request to service sponsored listings arrives. Similarly, process 308 may be dormant until activated in a number of manners; for example, the crawl operation could be set to commence based at least in part on one or more of the following: (1) at periodic time intervals; (2) upon occurrence of a preset number of sponsored listing requests; and (3) upon reception of update message information as previously described.

In this manner, data structure 200 is constructed having no duplicate landing page URLs, and similarly, landing page content database 50 will contain no duplicated sponsored listings, thereby minimizing the storage size of the databases and preventing crawling of duplicate landing page content.

### Example Timer Data Structure and Method

Additional refinements to the example methods and systems presented above can be made so as to further minimize unnecessary crawling of landing page content. For a variety of reasons, landing page content may exist in landing page content database 50 for which no crawling need currently be performed, in large part due to the ephemeral nature of sponsored content advertising.

For example, a sponsored listing may have a pre-specified time component in which the sponsored listing may be used; for example, a coffee advertisement is only to be included as a sponsored listing in the morning hours. Other sponsored listings may expire on a daily basis once a daily or monthly budget allocation has been reached. Yet other sponsored listings may be tied to particular holidays, e.g. flower advertisements near Mother's Day. This tumult is exacerbated by the continual addition of new advertisers and the departure of existing advertisers.

In an embodiment, database structure 200 is modified to include a queue designation and a timer value in each record corresponding to a landing page URL. In an embodiment, the URL identifier, queue designation, and timer value exist in a separate table or other data structure. A landing page URL may then be considered to reside on one of two queues: an “Active” queue or an “Inactive” or “Sleeping” queue.

An “Active URL Queue” would then comprise all URLs (or URL identifiers) associated with one or more sponsored listings that are currently active and eligible for presentation to one or more users. Crawler 40 is then configured to crawl all landing page URLs referenced by the Active URL Queue. In an embodiment, crawler 40 is configured to crawl all landing page URLs referenced by the Active URL Queue in a continuous or near-continuous fashion, concurrently with the creation, addition, and modification of landing page sponsored listings.

A “Sleeping URL Queue” would then comprise all URLs (or URL identifiers) associated with sponsored listings that are currently inactive. In an embodiment, meta information corresponding to entries on the Sleeping URL Queue is retained, whereas actual landing page content corresponding to entries is not retained in landing page database 50. Crawler 40 is configured to refrain from crawling landing page content for those URLs in the Sleeping URL Queue.

FIG. 4 depicts a method of transitioning landing page URLs from Active to Sleeping and vice versa. Placement of a URL on the Active Queue begins at step 400; placement of a URL on the Sleeping Queue begins at step 450.

For placement of a URL on the Active Queue, at step 404, the URL is included in the next crawl performed by online crawler system 60. Information such as the landing page corresponding to the landing page URL is placed in landing page content database 50 as previously described.

At step 408, it is determined whether the URL has at least one active sponsored listing. If affirmative, then the step is repeated. Once the URL has no active sponsored listings, at step 412 a local timer associated with the URL is activated, starting at time zero. At step 416, it is determined whether a sponsored listing has been activated for the URL. If affirmative, then at step 420 the local timer is deactivated, with control passing back to decision step 408.

If no sponsored listing has been activated for the URL, then the local timer is compared to a pre-set selected value at step 424. This value may be set globally for entries in the queue, or this value may be set independently for each landing page URL. Should the local timer exceed the pre-set selected value, then the URL is moved to the Sleeping Queue at step 428, with further processing beginning at step 450. Should the local time not exceed the pre-set selected value, then control is passed back to decision step 418.

Upon placement of a URL on the Sleeping Queue at step 450, the URL is excluded from future crawling operations performed by online crawler system 60 at step 454. In an embodiment, information such as the landing page text corresponding to the landing page URL is removed from landing page content database 50, thereby conserving storage space, although meta information (such as the account identifier and sponsored listing identifier illustrated in FIG. 2) is retained in landing page content database 50.

At step 458, it is determined whether a sponsored listing has been activated for the URL. Should a sponsored listing be activated, then the URL is moved to the Active Queue, with further processing at step 400. Should no sponsored listing be activated, then the URL remains on the Sleeping Queue, and control is passed back to decision step 458.

Implementation of the Active Queue and Sleeping Queue can result in significant reductions of the disk space necessary to store landing page content. In one example, landing page content storage was reduced over 50%. Similarly, the number of entries on the Active Queue was reduced over 65% when compared to the total number of landing page URL entries. Also, by avoiding the crawling of inactive listings, a larger quantity of active listings can be crawled during a time period than would be possible otherwise.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

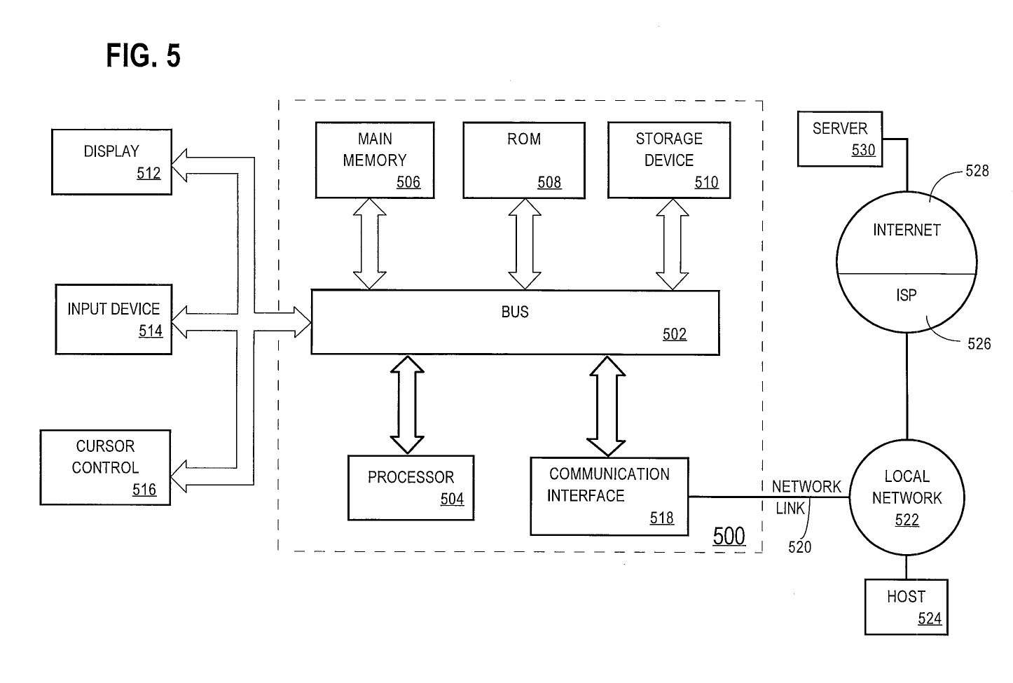

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
in response to acceptance of a landing page URL submitted by an entity, determining whether the landing page URL is already represented in a table;
in response to determining that the landing page URL is already represented in the table, adding entity information about the entity to a table entry corresponding to the landing page URL; and
crawling one or more landing pages based at least in part on one or more of the landing page URLs represented in the table;
wherein the method is performed by one or more special-purpose computing devices.

2. The method recited in claim 1, wherein the entity information includes account information and sponsored listing information.

3. The method recited in claim 2, wherein the sponsored listing information includes keywords associated with one or more search queries.

4. The method recited in claim 3, further comprising comparing the keywords to the content of one or more corresponding landing pages.

5. The method recited in claim 1, wherein each landing page URL is represented in the table by a unique identifier.

6. The method recited in claim 5, wherein each unique identifier is determined using a hashing function.

7. The method recited in claim 1, wherein each landing page corresponds to information displayed as part of a search results page.

8. A method comprising:
placing a URL identifier associated with a landing page URL and the corresponding landing page in an active queue;
crawling one or more landing pages on the active queue;
determining a time interval since a last active sponsored listing associated with the URL identifier has become inactive;
if the time interval is greater than a pre-selected duration, placing the URL identifier on an inactive queue and discarding a stored copy of the corresponding landing page; and
if a sponsored listing associated with a URL identifier in the inactive queue is activated, moving the URL identifier in the inactive queue to the active queue and associating the corresponding landing page in the active queue;
wherein the method is performed by one or more special-purpose computing devices.

9. The method recited in claim 8, wherein each landing page corresponds to information displayed as part of a search results page.

10. The method recited in claim 8, wherein each URL is represented in the active queue by a unique identifier.

11. The method recited in claim 8, wherein the active queue includes entity information associated with the URL identifier.

12. The method recited in claim 11, wherein the entity information includes account information and sponsored listing information.

13. The method recited in claim 12, wherein the sponsored listing information includes keywords associated with one or more search queries.

14. The method recited in claim 13, further comprising comparing the keywords to the content of one or more corresponding landing pages.

15. One or more storage media storing instructions which, when executed by one or more computing devices, cause performance of the method recited in claim 1.

16. One or more storage media storing instructions which, when executed by one or more computing devices, cause performance of the method recited in claim 2.

17. One or more storage media storing instructions which, when executed by one or more computing devices, cause performance of the method recited in claim 3.

18. One or more storage media storing instructions which, when executed by one or more computing devices, cause performance of the method recited in claim 4.

19. One or more storage media storing instructions which, when executed by one or more computing devices, cause performance of the method recited in claim 5.

20. One or more storage media storing instructions which, when executed by one or more computing devices, cause performance of the method recited in claim 6.

21. One or more storage media storing instructions which, when executed by one or more computing devices, cause performance of the method recited in claim 7.

22. One or more storage media storing instructions which, when executed by one or more computing devices, cause performance of the method recited in claim 8.

23. One or more storage media storing instructions which, when executed by one or more computing devices, cause performance of the method recited in claim 9.

24. One or more storage media storing instructions which, when executed by one or more computing devices, cause performance of the method recited in claim 10.

25. One or more storage media storing instructions which, when executed by one or more computing devices, cause performance of the method recited in claim 11.

26. One or more storage media storing instructions which, when executed by one or more computing devices, cause performance of the method recited in claim 12.

27. One or more storage media storing instructions which, when executed by one or more computing devices, cause performance of the method recited in claim 13.

28. One or more storage media storing instructions which, when executed by one or more computing devices, cause performance of the method recited in claim 14.
